(19) United States
(12) Patent Application Publication
(10) Pub. No.: US 2022/0405110 A1
(43) Pub. Date: Dec. 22, 2022

(54) NON-TRANSITORY COMPUTER-READABLE RECORDING MEDIUM AND COMPILATION METHOD

(71) Applicant: FUJITSU LIMITED, Kawasaki-shi (JP)

(72) Inventor: Keisuke TSUGANE, Kawasaki (JP)

(73) Assignee: FUJITSU LIMITED, Kawasaki-shi (JP)

(21) Appl. No.: 17/695,885

(22) Filed: Mar. 16, 2022

(30) Foreign Application Priority Data
Jun. 22, 2021 (JP) 2021-103222

(51) Int. Cl. G06F 9/455; G06F 8/41

(52) U.S. Cl. CPC G06F 9/45525; G06F 8/4441

(57) ABSTRACT

The present disclosure relates to a non-transitory computer-readable recording medium storing a complier that causes a computer to execute a process. The process includes generating a program. The program includes a first code that compares a first execution time from a start to an end of a loop processing when the loop processing is executed with a fixed-length SIMD instruction, with a second execution time from the start to the end of the loop processing when the loop processing is executed with a variable-length SIMD instruction, and a second code that executes the loop processing with the variable length SIMD instruction when a result of the comparison reveals that the first execution time is longer than the second execution time.

### CROSS-REFERENCE TO RELATED APPLICATION

This application is based upon and claims the benefit of priority of the prior Japanese Patent Application No. 2021-103222 filed on Jun. 22, 2021, the entire contents of which are incorporated herein by reference.

### FIELD

A certain aspect of the embodiments is related to a non-transitory computer-readable recording medium and a compilation method.

### BACKGROUND

One of the compiler optimization methods is to replace an instruction in the loop processing written in a program with a SIMD (Single Instruction Multiple Data) instruction. In this method, a plurality of elements that are operands of the instruction are assigned to a plurality of vector registers, respectively, and the instruction is executed in these vector registers in parallel. This improves an execution speed of the program compared to sequential execution of the instruction in the loop processing.

However, since a bit length of the SIMD instruction is fixed for each processor, when the SIMD instruction is executed on a plurality of processors with registers having different bit lengths, it is necessary to perform compilation for each processor, which reduces the portability of the program. Hereinafter, the SIMD instruction whose bit length is fixed for each processor is referred to as a fixed-length SIMD instruction.

A variable length SIMD instruction is available to solve this problem of the fixed-length SIMD instruction. The bit length of the variable length SIMD instruction is variable to match the bit length of the registers provided in the processor. Therefore, once the program is compiled and an executable program is generated, the executable program can be executed on other processors with registers having different bit lengths, increasing the portability of the program.

When the loop processing is executed with the variable length SIMD instruction, the total number of times of execution of the loop processing may not be divisible by the bit length of the register, resulting in occurrence of a remainder. In this case, it is not necessary to store an operation result of the loop processing in each bit of the register corresponding to the remainder. Therefore, when the variable length SIMD instruction is used for loop processing, an instruction called a mask instruction is executed to obtaining the remainder.

However, the overhead of that mask instruction may cause the program execution speed to be slower than when the fixed-length SIMD instruction is executed. Note that the technique related to the present disclosure is disclosed in (1) Japanese Laid-open Patent Publication No. 2012-174016, (2) Japanese Laid-open Patent Publication No. 2018-92383, (3) Stephens, Nigel, et al., “The ARM scalable vector extension”, IEEE micro 37.2 (2017): 26-39, and (4) Jinpil LEE and Mitsuhisa Sato, “Proposal of an OpenMP Specification Extension for Application-Specific SIMD Optimization and Evaluation Using ARM SVE,” Research Report High Performance Computing (HPC) 2017.10 (2017): 1-8.

### SUMMARY

According to an aspect of the present disclosure, there is provided a non-transitory computer-readable recording medium storing a complier that causes a computer to execute a process, the process includes generating a program; wherein the program includes: a first code that compares a first execution time from a start to an end of a loop processing when the loop processing is executed with a fixed-length SIMD instruction, with a second execution time from the start to the end of the loop processing when the loop processing is executed with a variable-length SIMD instruction; and a second code that executes the loop processing with the variable length SIMD instruction when a result of the comparison reveals that the first execution time is longer than the second execution time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating a compiler device according to the present embodiment;

FIG. 2 is a diagram illustrating the hardware configuration of a target machine;

FIG. 3 is a schematic diagram of a register file included in a processor of the target machine;

FIG. 4A is a diagram illustrating a pseudo source code of C language to explain a mask instruction;

FIGS. 4B and 4C are schematic diagrams for explaining a whilelo instruction which is an example of the mask instruction provided in SVE;

FIG. 5 is a schematic diagram illustrating a state where the loop processing is executed with the variable length SIMD instruction when a predicate vector of the mask register is represented by FIG. 4C;

FIG. 6 is a schematic diagram illustrating processing performed by a control unit in the compiler device;

FIG. 7 is a schematic diagram illustrating specific examples of an input source program and an intermediate source program;

FIG. 8 is a diagram illustrating the functional configuration of the compiling device according to the present embodiment;

FIG. 9A is a schematic diagram illustrating the input source program;

FIG. 9B is a schematic diagram illustrating a call graph generated from the input source program by a call graph generation unit;

FIG. 10A is a schematic diagram illustrating the input source program in which a function func1( ), which is a source of a control flow graph, is written;

FIG. 10B is a schematic diagram illustrating the control flow graph of the function func1( ) generated by a control flow graph generation unit based on the input source program of FIG. 10A;

FIG. 11 is a flowchart illustrating a compilation method according to the present embodiment; and

FIG. 12 is a diagram illustrating the hardware configuration of the compiler device according to the present embodiment.

### DESCRIPTION OF EMBODIMENTS

It is an object of the present disclosure to suppress a decrease in the execution speed of the program.

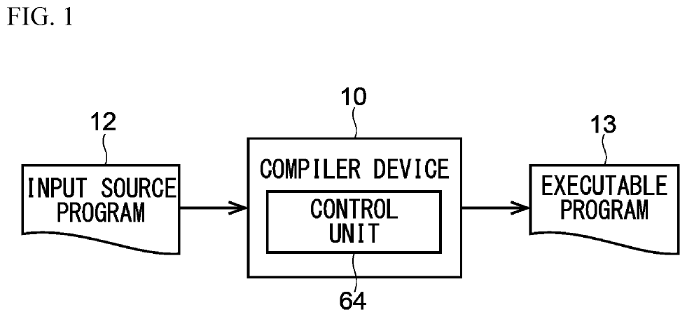

FIG. 1 is a schematic diagram illustrating a compiler device according to the present embodiment.

A compiler device 10 is a computer such as a physical machine or virtual machine, and includes a control unit 64 that converts an input source program 12 into an executable program 13. The executable program 13 is a binary file that can be executed on a target machine such as HPC (High Performance Computer).

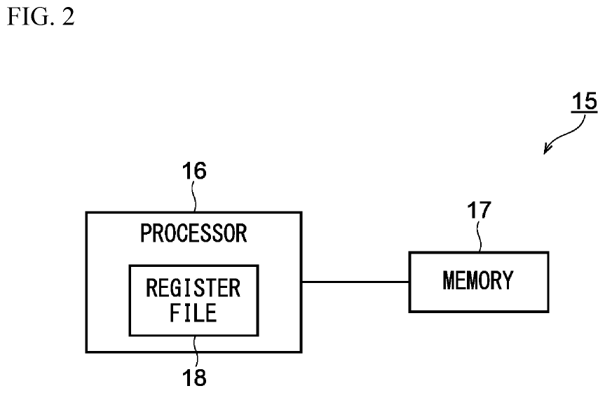

FIG. 2 is a diagram illustrating the hardware configuration of a target machine. As illustrated in FIG. 2, a target machine 15 includes a processor 16 and a memory 17. The processor 16 and the memory 17 work together to execute the executable program 13. The processor 16 includes a register file 18 that stores instructions, data, and so on.

The following explanation is based on a case where the processor 16 is an A64FX manufactured by Fujitsu Limited. The A64FX is a processor capable of executing both SVE (Scalable Vector Extension) which is a variable length SIMD instruction set that extends the Armv8.2-A instruction set, and NEON of ARM Ltd. which is an instruction set of the fixed-length SIMD instruction.

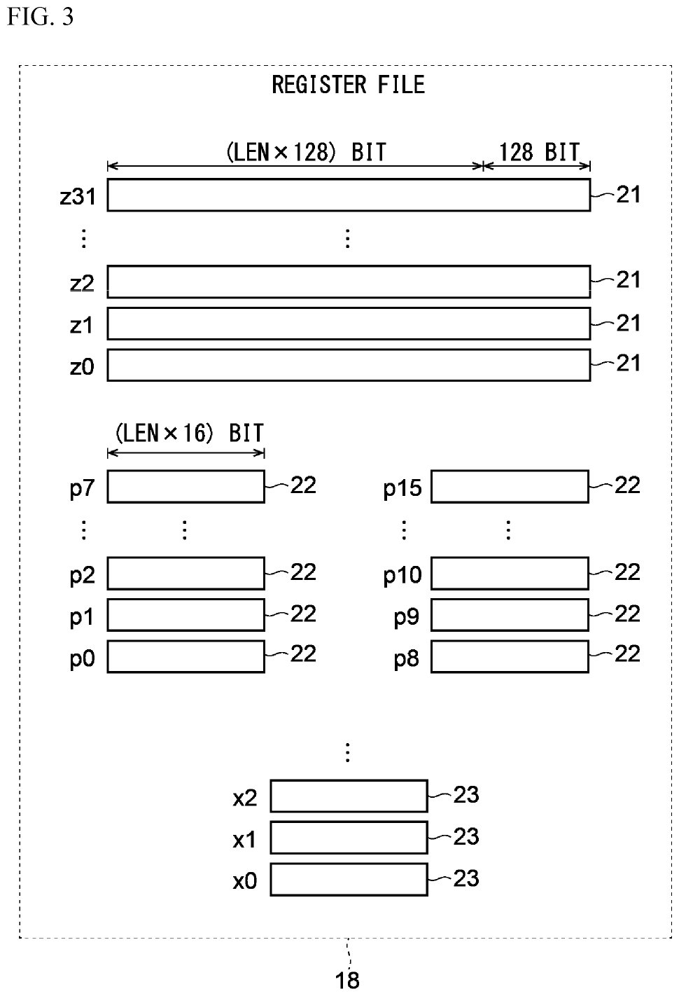

FIG. 3 is a schematic diagram of the register file 18 included in the processor 16 of the target machine 15.

As illustrated in FIG. 3, the register file 18 has a plurality of vector registers 21, a plurality of mask registers 22, and a plurality of scalar registers 23.

The vector register 21 is a (LEN×128+128)-bit length register for executing the SIMD instruction. The “LEN” is an integer value between 0 and 15 supported by the bit length of the variable length SIMD instruction. Hereinafter, the plurality of vector registers 21 are identified by character strings “z0”, “z1”, . . . “z31”, respectively.

The mask register 22 is a (LEN×16)-bit length register for executing the mask instruction. The plurality of mask registers 22 are identified by character strings “p0”, “p1”, . . . “p15”, respectively.

The scalar register 23 is a register for holding a scalar variable. Hereinafter, the plurality of scalar registers 23 are identified by character strings “z0”, “z1”, . . . “z31”, respectively.

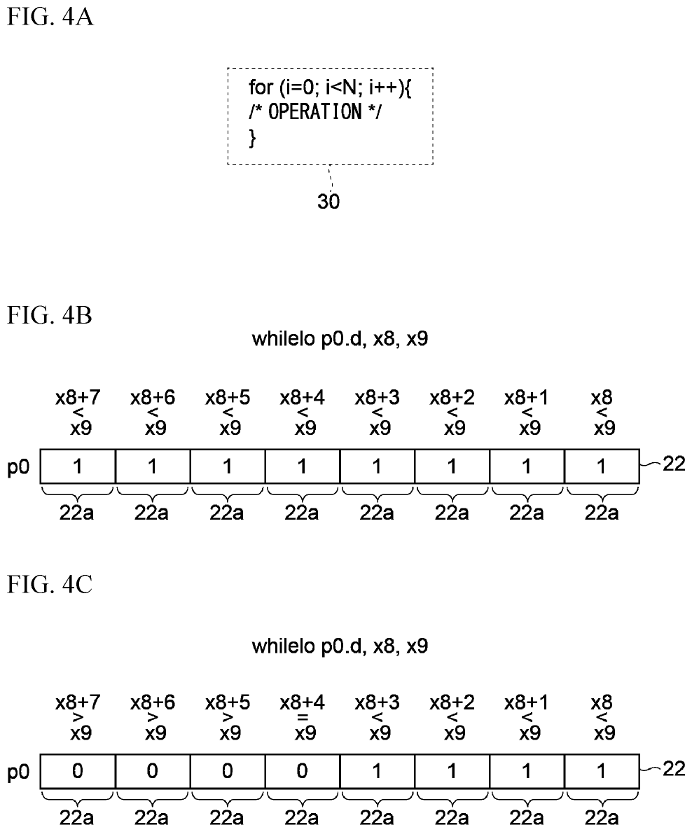

Next, a description will be given of the mask instruction using the mask register 22. FIG. 4A is a diagram illustrating a pseudo source code of C language to explain the mask instruction. All the source code that appears after this is the pseudo source code in the C language.

Here, loop processing 30 by the for statement will be described as an example. An “i” in this loop processing 30 is an iteration indicating the number of times of execution of the loop processing 30. An “N” indicates the loop length which is the total number of times of execution of the loop processing.

FIGS. 4B and 4C are schematic diagrams for explaining a whilelo instruction which is an example of the mask instruction provided in SVE.

When the loop processing 30 is executed, the iteration “i” is stored in the scalar register 23 of “x8”, and the loop length “N” is stored in the scalar register 2 of “x9”. Hereinafter, it is assumed that the value of “LEN” is 3 and the bit lengths of the vector register 21 and the mask register 22 are 512 bits and 48 bits, respectively.

The whilelo instruction is an instruction to determine whether the loop length “N” stored in the scalar register 23 of “x9” is greater than each of values obtained by adding 0, 1, . . . , 7 to the iteration “i” stored in the scalar register 23 of “x8”. If this determination is YES, the whilelo instruction stores “1” in eight storage areas 22a in which the mask register 22 having 48-bit length “p0” is divided every 6 bits. In the example of FIG. 4B, “1” is stored in all storage areas 22a of the mask register 22 of “p0”. In this case, the number of times of execution of the loop processing 30 in FIG. 4A does not reach “N”, and the loop processing 30 is continued. A vector whose component is a values stored in each storage area 22a is called a predicate vector. In the example of FIG. 4A, the predicate vector is (1, 1, 1, 1, 1, 1, 1, 1, 1, 1).

In the example of FIG. 4C, the value of “i+3” is smaller than “N”, but a value of each of “i+4”, “i+5”, “i+6”, and “i+7” is larger than “N”. In this case, the whilelo instruction stores “0” in the storage area 22a corresponding to each of “i+4”, “i+5”, “i+6”, and “i+7”. Thereby, the predicate vector stored in the mask register 22 of “p0” becomes (0, 0, 0, 0, 0, 1, 1, 1, 1, 1). A component having a value of “1” among the components of the predicate vector corresponds to the iteration in which the loop processing 30 needs to be executed. A component having a value of “0” corresponds to the iteration that is larger than the total number of times of execution “N” of the loop processing 30 and does not need to be executed. In this way, the number of storage areas 22a in which “0” is stored is equal to the remainder when the total number of times of execution “N” of the loop processing 30 is divided by 8, which is the number of storage areas 22a.

The whilelo instruction, which is a mask instruction, is an instruction that identifies the iterations that do not need to be executed greater than the total number of times of execution “N” of the loop processing based on such a predicate vector.

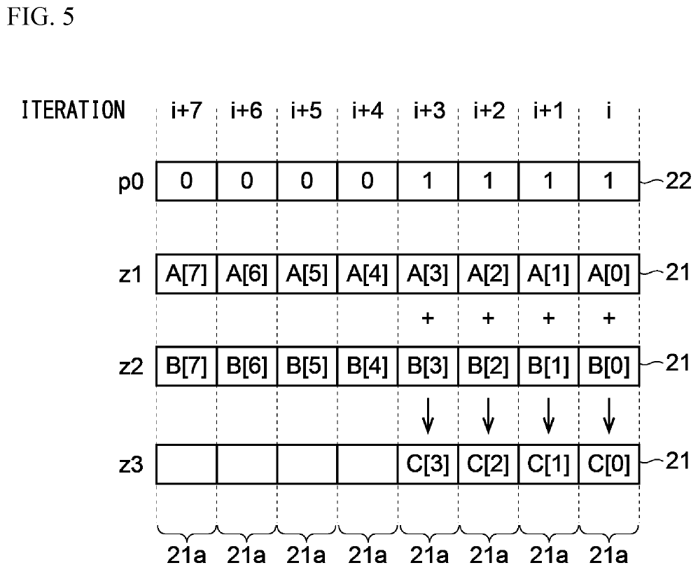

FIG. 5 is a schematic diagram illustrating a state where the loop processing 30 is executed with the variable length SIMD instruction when the predicate vector of the mask register 22 is represented by FIG. 4C.

In the example of FIG. 5, it is assumed that the “operation” in the loop processing 30 of FIG. 4A is an operation of the variable length SIMD instruction that adds an array “A” to an array “B” every elements and stores the results in the elements of an array “C”.

In addition, it is assumed that the elements “A[0]” to “A[7]” of the array “A” are stored in respective storage areas 21a of the vector register 21 of “z1”, and the elements “B[0]” to “B[7]” of the array “B” are stored in the respective storage areas 21a of the vector register 21 of “z2”.

The elements “A[0]” to “A[7]” are the elements corresponding to respective iterations “i” to “i+8” of the loop processing 30. The elements “B[0]” to “B[7]” are similarly elements corresponding to the respective iterations “i” to “i+8” of the loop processing 30. Similarly, the elements “C[0]” to “C[3]” correspond to the iterations “i” to “i+3”.

In this case, the variable length SIMD instruction operates the elements corresponding to the iterations having the component of “1” in the predicate vector in the mask register 22 of “p0”, and writes the operation results into the vector register 21 of “z3”. On the other hand, the variable length SIMD instruction does not write the operation results in the iterations having the component of “0” in the predicate vector into the vector register 21 of “z3”.

Thereby, only the operation results when the iterations are smaller than the loop length “N” are written into the vector register 21 of “z3”. Therefore, even if the bit length of the vector register 21 varies depending on the processor 16, only the operation results when the iterations are less than or equal to the loop length “N” can be stored in the vector register 21.

In this way, the mask instruction can be used to execute the variable length SIMD instruction, and a single executable program 13 that can be executed by a plurality of processors 16 with the vector registers 21 having different lengths can be obtained.

However, since the overhead of the whilelo instruction which is the mask instruction is required to execute the variable length SIMD instruction, the execution speed of the executable program 13 may be lower than that of the fixed-length SIMD instruction.

Therefore, in the present embodiment, the control unit 64 in the compiler device 10 generates a code to execute the loop processing with an instruction that reduces the execution time of the executable program 13 among the variable length SIMD instruction and the fixed-length SIMD instruction as follows.

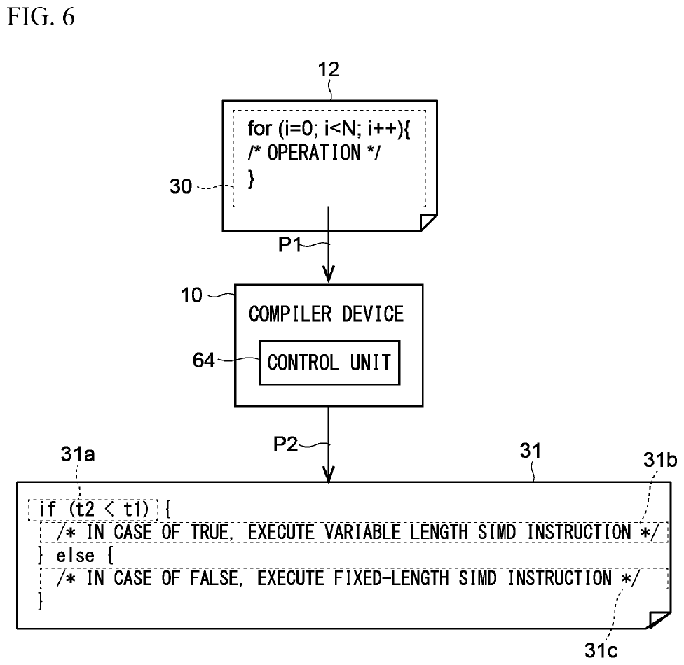

FIG. 6 is a schematic diagram illustrating processing performed by the control unit 64 in the compiler device 10.

First, the control unit 64 acquires the input source program 12 to be compiled (step P1). It is assumed that the loop processing 30 described above is written in the input source program 12.

Next, the control unit 64 compiles the input source program 12 to generate an intermediate source program 31 in which first to third codes 31a to 31c are written (step P2). The control unit 64 further compiles the intermediate source program 31 to generate the executable program 13, but the details thereof are omitted here.

The first code 31a in the intermediate source program 31 is a code that compares a first execution time t1 with a second execution time t2. The first execution time t1 is an execution time from the start to the end of the loop processing 30 when the loop processing 30 is executed with the fixed-length SIMD instruction. The second execution time t2 is an execution time from the start to the end of the loop processing 30 when the loop processing 30 is executed with the variable length SIMD instruction.

The second code 31b is a code that executes the loop processing 30 with the variable length SIMD instruction when the first execution time t1 is found to be longer than the second execution time t2 by the first code 31a. For example, the SVE (Scalable Vector Extension) of ARM Ltd. is an instruction set for such a variable length SIMD instruction.

The third code 31c is a code that executes the loop processing 30 with the fixed-length SIMD instruction when the first execution time t1 is found to be not longer than the second execution time t2 by the first code 31a. For example, the NEON of ARM Ltd. is an instruction set for such a fixed-length SIMD instruction.

Next, a method of calculating the first execution time t1 and the second execution time t2 will be described.

First, parameters are defined as follows.

a: Loop length in the loop processing 30. In the example of FIG. 6, “a”=N.

b: Cost of the mask instruction. In this example, the latency of the whilelo instruction is “b”.

c: Bit length of the variable used inside the loop processing 30. For example, when the arrays A, B, and C are used inside the loop processing 30 as illustrated in FIG. 5, the bit length of each of elements A[i], B[i], and C[i] in these arrays becomes “c”. If a plurality of variables with different bit lengths exist inside the loop processing 30, the one having the largest bit length among the plurality of variables becomes “c”.

d: Bit length of the vector register 21.

e: Bit length of the fixed-length SIMD instruction.

f: Loop length when the loop processing 30 is executed with the variable length SIMD instruction. The number of iterations that can be executed in the single vector register 21 when executing the variable length SIMD instruction once is “d/c”, and an original loop length is “a”, so that f can be expressed by “a/(d/c)” (i.e. f=a/(d/c)).

g: Loop length when the loop processing 30 is executed with the fixed-length SIMD instruction. The number of iterations that can be executed in the single vector register 21 when executing the fixed-length SIMD instruction once is “e/c”, and the original loop length is “a”, so that g can be expressed by “a/(e/c)” (i.e. g=a/(e/c)).

h: Cost when the loop processing 30 is executed once. Hereinafter, this cost is referred to as an iteration cost. Here, it is assumed that “h” is the latency of a cmp instruction which determines whether iteration “i” is smaller than the loop length “a”.

Under the above definition, each of the first execution time t1 and the second execution time t2 is given by the following equation in the present embodiment.

t1=g×h

t2=f×(b+h)

A reason why the first execution time t1 is set to “g×h” is that a processing with the iteration cost of “h” needs to be executed a total of g times to obtain the same execution result as the original loop processing 30. As a result, the first execution time t1 of the loop processing 30 taking into account the iteration cost h can be obtained.

For the same reason, the second execution time t2 is set to “f×(b+h)”. A reason why “f×b” is included in the second execution time t2 is that the mask instruction must be executed for each iteration, and the total cost of the mask instruction will be “f×b” if the iterations are performed a number of times equal to the loop length “f”. Thus, the second execution time t2 is set as “f×(b+h)”, so that it is possible to obtain the second execution time t2 of the loop processing 30 which takes into account both the iteration cost “h” and the cost “b” of the mask instruction.

According to the intermediate source program 31, if t2<t1 is satisfied, the processor 16 executes the second code 31b that executes the loop processing 30 with the variable length SIMD instruction. Therefore, the speed of the executable program 13 can be increased compared to the case where the loop processing 30 is executed with the fixed-length SIMD instruction.

On the other hand, if t2<t1 is not satisfied, the processor 16 executes the third code 31c that executes the loop processing 30 with the fixed-length SIMD instruction. In this case, the speed of the executable program 13 can be increased compared to the case where the loop processing 30 is executed with the variable length SIMD instruction.

Furthermore, since the cost “f×b” of the mask instruction is included in the second execution time t2, the first code 31a can determine whether t2<t1 is satisfied while taking the cost into account.

In this example, both the input source program 12 and the intermediate source program 31 are source programs, but the present embodiment is not limited to this. For example, the control unit 64 of the compiler device 10 may obtain an intermediate code such as an assembly program equivalent to the input source program 12, instead of the input source program 12. Similarly, the control unit 64 may generate the intermediate code such as the assembly program equivalent to the intermediate source program 31, instead of the intermediate source program 31.

Next, specific examples of the input source program 12 and the intermediate source program 31 will be described.

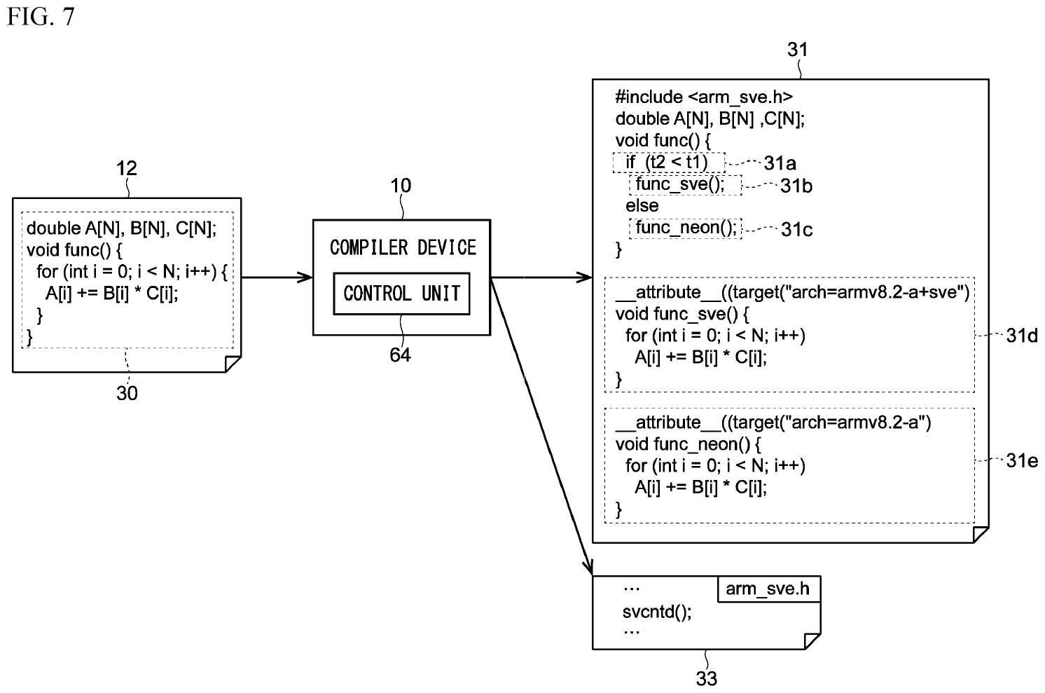

FIG. 7 is a schematic diagram illustrating specific examples of the input source program 12 and the intermediate source program 31. In FIG. 7, the same elements as those in FIG. 6 are designated by the same reference numerals in FIG. 6, and the description thereof will be omitted below.

In this example, the loop processing 30 of the input source program 12 is the process of executing the operation to assign a value obtained by multiplying the array elements “B[i]” and “C[i]” to the array element “A[i]” in the i-th iteration. It is assumed that each element of the arrays A, B, and C is a double type.

After obtaining this input source program 12, the control unit 64 generates the intermediate source program 31. The intermediate source program 31 includes the first to third codes 31a to 31c.

The first code 31a is a code that determines whether the first execution time t1 is longer than the second execution time t2, as in the example in FIG. 6.

A function func_sve( ) included in the second code 31b is a code that executes the loop processing 30 with the variable length SIMD instructions of the SVE. Then, a function func_neon( ) included in the third code 31c is a code that executes the loop processing with the fixed-length SIMD instruction of the NEON.

Furthermore, the control unit 64 generates a fourth code 31d that defines the above-mentioned function func_sve( ) and a fifth code 31e that defines the above-mentioned function func_neon( ) in the intermediate source program 31.

In this example, the control unit 64 also generates a header file 33 in C language that describes a function svcntd( ) that returns the bit length of the vector register 21. The header file 33 is named “arm_sve.h” and is referenced in a first line of the intermediate source program 31.

Next, a value of each parameter when the A64FX processor is used as the processor 16 will be described.

Loop length “a”=N.

Cost “b” of the mask instruction=4. Since the latency of the whilelo instruction executed by the A64FX processor is 4, the cost “b” of the mask instruction is 4 (b=4).
Bit length “c” of the variable=sizeof(double)×8. Since each element of the arrays A, B, and C in the loop processing 30 is the double type, and a byte length of the variable of the double type is “sizeof(double)”, the bit length of each element is “sizeof(double)×8”. The function “sizeof” is a function that returns the byte length of an argument.
Bit length “d” of the vector register 21=svcnd( )×sizeof(double)×8. Since a return value of the function svcnd( ) is of the double type, the bit length “d” is a value obtained by multiplying the return value by “sizeof(double)” and 8.
Bit length “e” of the fixed-length SIMD instruction=128. Since the bit length of the fixed-length SIMD instruction of the NEON is 128 bits, “e” is 128 (e=128).
Loop length “f” when the loop processing 30 is executed with the variable length SIMD instruction=a/(d/c)=N/(svcntd( )×sizeof(double)×8/sizeof(double)×8)=N/svcntd( ).

Loop length “g” when the loop processing 30 is executed with the fixed-length SIMD instruction=a/(e/c)=N/(128/sizeof(double)×8).

Cost “h” when the loop processing 30 is executed once=2. Since the latency of the cmp instruction executed by the A64FX processor is 2, “h” is 2 (h=2).

When the respective parameters are given in this way, the first execution time t1 and the second execution time t2 are as follows.

t1=g×h=N/(128/sizeof(double)×8)×2

t2=f×(b+h)=N/svcntd( )×(4+2)

Thereby, the processor 16 executes func_sve( ) of the second code 31b when “t1>t2” is satisfied, and executes func_neon( ) of the third code 31c when “t1>t2” is not satisfied.

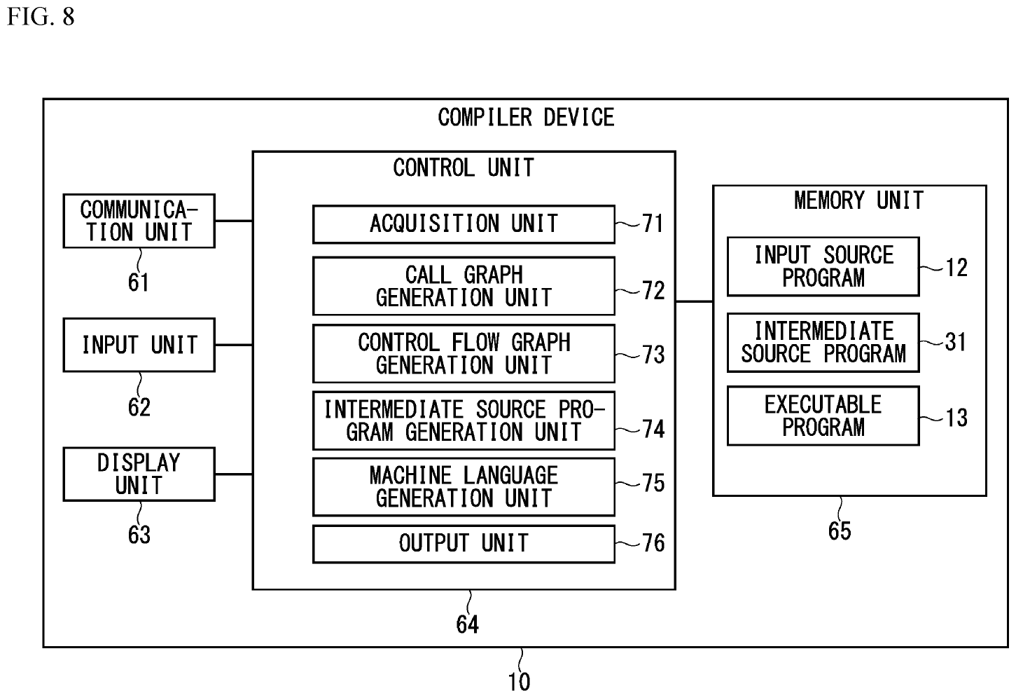

Next, the functional configuration of the compiler device 10 will be described. FIG. 8 is a diagram illustrating the functional configuration of the compiler device 10 according to the present embodiment. As illustrated in FIG. 8, the compiler device 10 includes a communication unit 61, an input unit 62, a display unit 63, the control unit 64, and a memory unit 65.

The communication unit 61 is a processing unit for connecting the compiler device 10 to a network such as an Internet or a LAN (Local Area Network). The input unit 62 is a processing unit for the user to input various data to the compiler device 10.

The display unit 63 is a processing unit that displays compilation results, errors that occurred during compilation, and other information. The memory unit 65 stores each of the input source program 12, the executable program 13, and the intermediate source program 31.

The control unit 64 is a processing unit that controls each part of the compiler device 10. As an example, the control unit 64 includes an acquisition unit 71, a call graph generation unit 72, a control flow graph generation unit 73, an intermediate source program generation unit 74, a machine language generation unit 75, and an output unit 76.

The acquisition unit 71 acquires the input source program 12 to be compiled via the communication unit 61 and stores it in the memory unit 65.

The call graph generation unit 72 is a processing unit that identifies a caller function and a callee function written in the input source program 12 and generates a call graph having these functions as nodes.

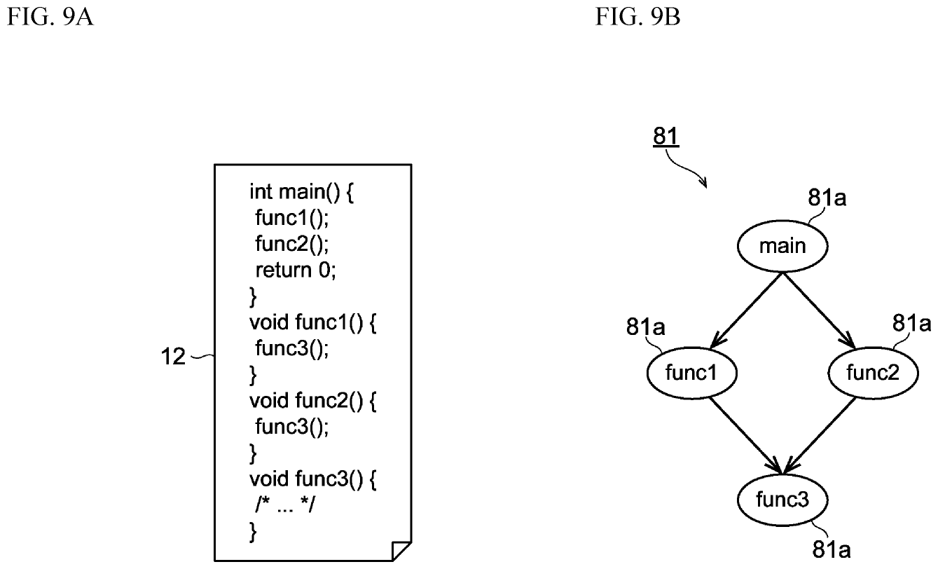

FIG. 9A is a schematic diagram illustrating the input source program 12. FIG. 9B is a schematic diagram illustrating a call graph 81 generated from the input source program 12 by the call graph generation unit 72.

As illustrated in FIG. 9A, it is assumed that a function main( ), a function func1( ), a function func2( ), and a function func3( ) are written in the input source program 12. Here, it is assumed that the function main( ) calls the functions func1( ) and func2( ), and each of the functions func1( ) and func2( ) calls the function func3( ).

In this case, the call graph generation unit 72 generates the call graph 81 of FIG. 9B.

As illustrated in FIG. 9B, the call graph 81 is a function that sets functions described in the input source program 12 as nodes 81a. The call graph 81 is a valid graph, and a direction from the caller function to the callee function is a direction of each edge.

Referring to FIG. 8 again, the control flow graph generation unit 73 is a processing unit that generates a control flow graph of a function corresponding to each node 81a of the call graph 81.

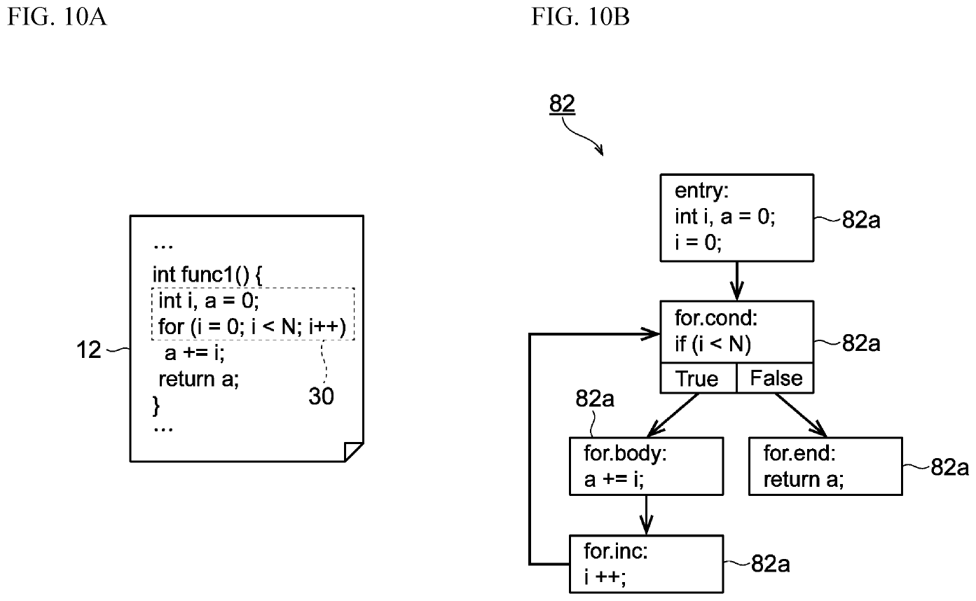

FIG. 10A is a schematic diagram illustrating the input source program 12 in which the function func1( ), which is a source of the control flow graph, is written.

As illustrated in FIG. 10A, it is assumed that the loop processing 30 using the for statement is described in the function func1( ).

FIG. 10B is a schematic diagram illustrating a control flow graph 82 of the function func1( ) generated by the control flow graph generation unit 73 based on the input source program 12 of FIG. 10A.

As illustrated in FIG. 10B, the control flow graph 82 is a graph that sets a basic block of the function func1( ) as nodes 82a. The basic block is a sequential code sequence that does not contain any internal branches.

A character string with a colon attached to each node 82a, such as “entry:”, is a label generated by the control flow graph 82 to identify each node 82a. For example, “for.cond:” is a label of the basic block that determines whether the iteration “i” is smaller than the loop length “N” in the loop processing 30.

The control flow graph 82 is a directed graph, and the direction of each edge indicates the flow of the program.

Referring to FIG. 8 again, the intermediate source program generation unit 74 is a processing unit that generates the intermediate source program 31 from the input source program 12 according to a method illustrated in FIGS. 6 and 7, and stores it in the memory unit 65.

The machine language generation unit 75 generates the executable program 13 from the intermediate source program 31 and stores it in the memory unit 65.

As an example, the machine language generation unit 75 generates the intermediate code by performing lexical analysis, syntactic analysis and semantic analysis on the intermediate source program 31, and generates the executable program 13 from the intermediate code.

The output unit 76 is a processing unit that outputs the executable program 13 stored in the memory unit 65 to the outside of the compiler device 10 via the communication unit 61.

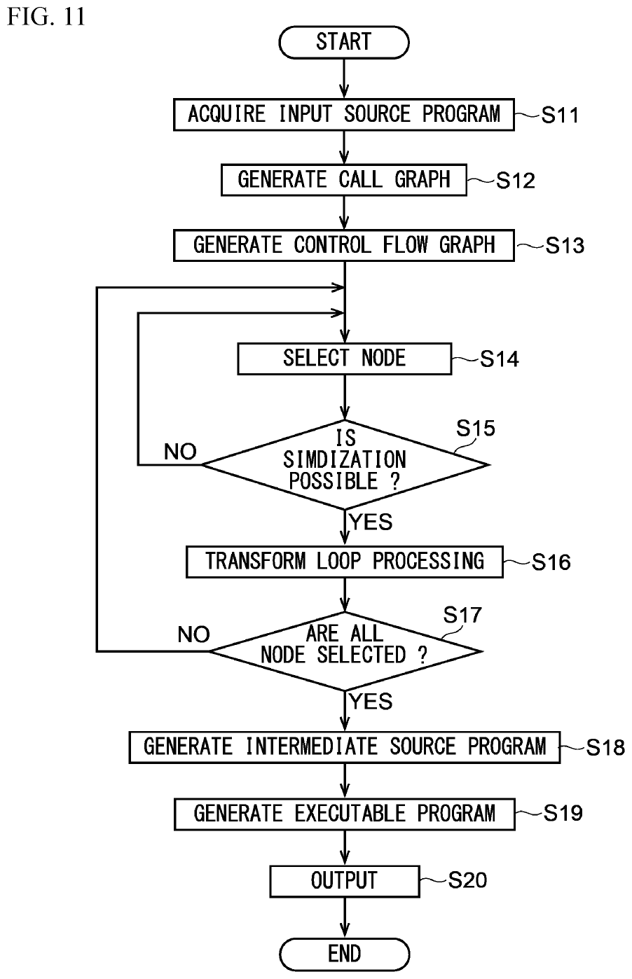

Next, a compilation method according to the present embodiment will be described. FIG. 11 is a flowchart illustrating the compilation method according to the present embodiment. First, the acquisition unit 71 acquires the input source program 12 (step S11). Next, the call graph generation unit 72 generates the call graph 81 in FIG. 9B based on the input source program 12 (step S12).

Furthermore, the control flow graph generation unit 73 generates the control flow graph 82 of FIG. 10B based on the input source program 12 (step S13).

Next, the intermediate source program generation unit 74 selects one of the plurality of nodes 81a included in the call graph 81 (step S14). In this example, when step S14 is first executed, the intermediate source program generation unit 74 selects a leaf node of the call graph 81.

Next, if there is the loop processing 30 identified by “for.cond:” in the control flow graph 82 corresponding to the selected node 81a, the intermediate source program generation unit 74 determines whether the loop processing 30 is SIMDized (Step S 15). The “SIMDization” means executing the loop processing with the fixed-length SIMD instruction or the variable length SIMD instruction.

For example, if there is a propagation dependency, in the loop processing 30, that uses the result of the iteration “i” in the iteration “j” (i≠j), it is not possible to execute the plurality of iterations simultaneously using the single vector register 21. Also, if the operations included in the loop processing 30 are scalar operations, an effect of parallel execution by the SIMDization is small. Therefore, the intermediate source program generation unit 74 determines that the loop processing 30 cannot be SIMDized if the loop processing 30 includes the propagation dependency or the scalar operation, and determines that the loop processing 30 can be SIMDized if not.

If the determination of step S15 is NO, the procedure returns to step S14 and the intermediate source program generation unit 74 selects an unselected node 81a in the call graph 81. An order in the selection of each node 81a is not limited. In this example, the intermediate source program generation unit 74 selects each node 81a in a direction of decreasing depth in order from the leaf node.

On the other hand, if the determination of step S15 is YES, the procedure proceeds to step S16. In step S16, the intermediate source program generation unit 74 transforms the loop processing 30 included in the node 81a selected in step S14.

For example, the intermediate source program generation unit 74 generates the first to third codes 31a to 31c from the loop processing 30 according to the method illustrated in FIGS. 6 and 7. As mentioned above, the first code 31a is a code that compares the first execution time t1 with the second execution time t2. And, the second code 31b is the code that executes the loop processing 30 with the variable length SIMD instruction, and the third code 31c is the code that executes the loop processing 30 with the fixed-length SIMD instruction.

Next, the intermediate source program generation unit 74 determines whether all the nodes 81a of the call graph 81 are selected (step S17). If the determination of step S17 is NO, the procedure returns to step S14. On the other hand, if the determination of step S17 is YES, the procedure proceeds to step S18.

In step S18, the intermediate source program generation unit 74 generates the intermediate source program 31 including the first to third codes 31a to 31c generated for each node 81a, and stores it in the memory unit 65.

As illustrated in FIG. 7, the intermediate source program generation unit 74 may generate the header file 33 in C language in which the function svcntd( ) that returns the bit length of the vector register 21 is written. Alternatively, the intermediate source program generation unit 74 may write the function svcntd( ) in the intermediate source program 31.

Next, the machine language generation unit 75 generates the executable program 13 from the intermediate source program 31 and stores it in the memory unit 65 (step S19). Then, the output unit 76 outputs the executable program 13 (step S20).

This completes the basic processing of the compilation method according to the present embodiment.

According to the present embodiment described above, in step S18, the intermediate source program generation unit 74 generates the intermediate source program 31 including the first to third codes 31a to 31c. If it is determined that t2<t1 is satisfied in the first code 31a, the processor 16 executes the second code 31b that executes the loop processing 30 with the variable length SIMD instruction. As a result, the speed of the executable program 13 can be increased compared to the case where the loop processing 30 is executed with the fixed-length SIMD instruction.

On the other hand, if t2<t1 is not satisfied, the processor 16 executes the third code 31c that executes the loop processing 30 with the fixed-length SIMD instruction. Therefore, the speed of the executable program 13 is increased compared to the case where the loop processing 30 is executed with the variable length SIMD instruction.

### (Hardware Configuration)

Next, a description will be given of a hardware configuration diagram of the compiler device 10 according to the present embodiment.

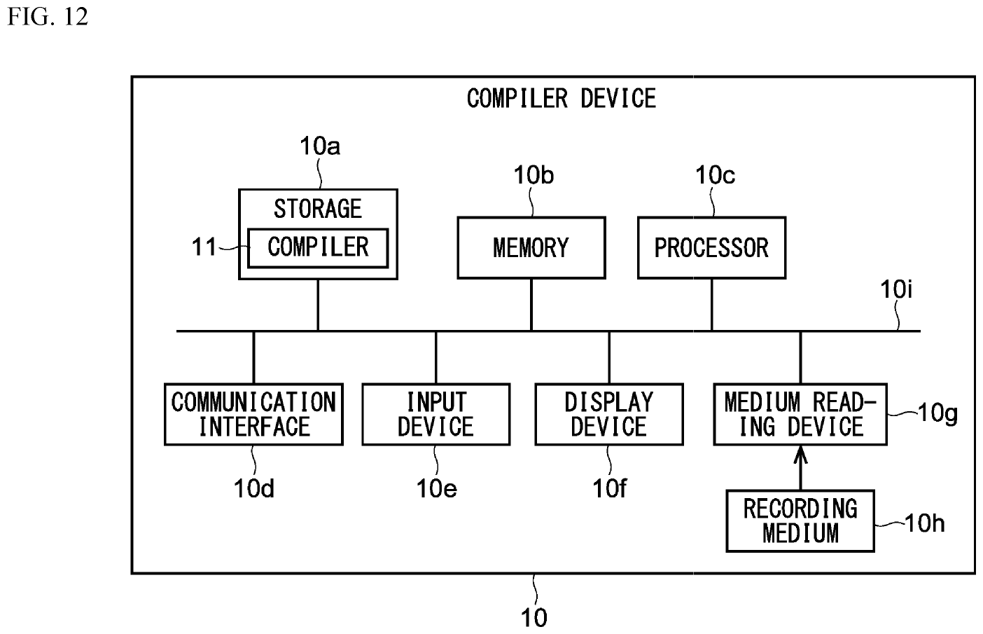

FIG. 12 is a hardware configuration diagram of the compiler device 10 according to the present embodiment.

The compiler device 10 is a computer such as a virtual machine or a physical machine, and includes a storage 10a, a memory 10b, a processor 10c, a communication interface 10d, an input device 10e, a display device 10f, and a medium reading device 10g. These elements are connected to each other by a bus 10i.

The storage 10a is a non-volatile storage such as an HDD (Hard Disk Drive) or an SSD (Solid State Drive), and stores a compiler 11 according to the present embodiment.

The compiler 11 may be recorded on a computer-readable recording medium 10h, and the processor 10c may be made to read the compiler 11 through the medium reading device 10g.

Examples of such a recording medium 10h include physically portable recording media such as a CD-ROM (Compact Disc-Read Only Memory), a DVD (Digital Versatile Disc), and a USB (Universal Serial Bus) memory. Further, a semiconductor memory such as a flash memory, or a hard disk drive may be used as the recording medium 10h. The recording medium 10h is not a temporary medium such as a carrier wave having no physical form.

Further, the compiler 11 may be stored in a device connected to a public line, the Internet, the LAN (Local Area Network), or the like. In this case, the processor 10c may read and execute the compiler 11.

Meanwhile, the memory 10b is hardware that temporarily stores data, such as a DRAM (Dynamic Random Access Memory).

The processor 10c is a CPU or a GPU (Graphical Processing Unit) that controls each part of the compiler device 10. Further, the processor 10c executes the compiler 11 in cooperation with the memory 10b.

In this way, the processor 10c and the memory 10b work together to execute the compiler 11, so that the function of the control unit 64 in FIG. 10 is realized. The control unit 64 includes the acquisition unit 71, the call graph generation unit 72, the control flow graph generation unit 73, the intermediate source program generation unit 74, the machine language generation unit 75, and the output unit 76.

Further, the communication interface 10d is hardware such as a NIC (Network Interface Card) for connecting the compiler device 10 to the network such as the Internet or the LAN (Local Area Network). The communication interface 10d realizes the communication unit 61 (see FIG. 8).

The input device 10e is hardware for realizing the input unit 62 (see FIG. 8). As an example, the input device 10e is a mouse, a keyboard or the like for the user to input various data into the compiler device 10.

Further, the display device 10f is hardware such as a liquid crystal display that displays the compilation result, the error occurred during compilation, and the like. The display device 10f realizes a display unit 66 of FIG. 8.

The medium reading device 10g is hardware such as a CD drive, a DVD drive, and a USB interface for reading the recording medium 10h.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A non-transitory computer-readable recording medium storing a complier that causes a computer to execute a process, the process comprising:
generating a program;
wherein the program includes:
a first code that compares a first execution time from a start to an end of a loop processing when the loop processing is executed with a fixed-length SIMD instruction, with a second execution time from the start to the end of the loop processing when the loop processing is executed with a variable-length SIMD instruction; and
a second code that executes the loop processing with the variable length SIMD instruction when a result of the comparison reveals that the first execution time is longer than the second execution time.

2. The non-transitory computer-readable recording medium as claimed in claim 1, wherein
the program includes a third code that executes the loop processing with the fixed-length SIMD instruction when the result of the comparison reveals that the first execution time is not longer than the second execution time.

3. The non-transitory computer-readable recording medium as claimed in claim 1, wherein
the variable-length SIMD instruction is an instruction that performs operation on each element stored in the plurality of storage areas provided in a register for the number of times of execution of the loop processing corresponding to the each element, and
the second execution time includes a cost of the mask instruction that identifies a storage area corresponding to the number of times of execution greater than the total number of times of executions of the loop processing.

4. The non-transitory computer-readable recording medium as claimed in claim 3, wherein
the cost of the mask instruction is a latency of the mask instruction.

5. The non-transitory computer-readable recording medium as claimed in claim 4, wherein
the second execution time is a value obtained by multiplying the total number of times of execution of the loop processing when the loop processing is executed with the variable length SIMD instruction by a sum of the latency of the mask instruction and a latency of an instruction to determine whether the number of times of execution of the loop processing is less than the total number of times of execution.

6. The non-transitory computer-readable recording medium as claimed in claim 1, wherein
the first execution time is a product of the total number of times of execution of the loop processing when the loop processing is executed with the fixed-length SIMD instruction, and a latency of an instruction that determines whether the number of times of execution of the loop processing is less than the total number of times of execution.

7. A compilation method for causing a computer to execute a process, the process comprising:
generating a program;
wherein the program includes:
a first code that compares a first execution time from a start to an end of a loop processing when the loop processing is executed with a fixed-length SIMD instruction, with a second execution time from the start to the end of the loop processing when the loop processing is executed with a variable-length SIMD instruction; and
a second code that executes the loop processing with the variable length SIMD instruction when a result of the comparison reveals that the first execution time is longer than the second execution time.
